(19) United States
(12) Patent Application Publication
(10) Pub. No.: US 2016/0050458 A1
(43) Pub. Date: Feb. 18, 2016

(54) METHOD AND APPARATUS FOR DIGITAL POLLING

(71) Applicants: Adam Lawrence Layton, Safford, AZ (US); Stephan Stavrakis, Coquitlam (CA); Michael Assum, Safford, AZ (US)

(72) Inventors: Adam Lawrence Layton, Safford, AZ (US); Stephan Stavrakis, Coquitlam (CA); Michael Assum, Safford, AZ (US)

(21) Appl. No.: 14/461,399

(22) Filed: Aug. 16, 2014

(51) Int. Cl. H04N 21/442; H04N 7/16; H04N 5/445; H04N 21/4782; H04N 21/258; H04N 21/431; H04N 21/2187; H04N 21/61; H04N 21/2543; H04N 21/81

(52) U.S. Cl. CPC H04N 21/44222; H04N 21/2543; H04N 7/162; H04N 5/445; H04N 21/8173; H04N 21/25891; H04N 21/431; H04N 21/2187; H04N 21/8133; H04N 21/6125; H04N 21/6175; H04N 21/4782

(57) ABSTRACT

Disclosed herein is a system and method of polling for feedback for performing artists at a designated website. The steps of method in accordance with this invention include viewing a performing artist at the designated website using a digital device, such website defining a starting point; viewing such performing artists on the designated website; receiving a first prompt from the proprietary software, after a predetermined time, requesting voluntarily tip information for the performing artist being viewed; using digital to communicate a response to the first prompt; if responding affirmatively, receiving a second prompt requesting information on amount of tip; using digital means to communicate to the proprietary software, and communicating the amount of the tip in response to the second prompt; if responding negatively to tipping, or after completing tip information, after responding affirmatively, receiving the next prompt requesting viewer information to continue viewing the same artist or to return to the starting point.

### FIELD OF THE INVENTION

The present invention relates to the field of social media. More particularly, the present invention relates to an apparatus and method for polling viewers to achieve tipping and feedback information from users over a mass online network, for example the internet.

### BACKGROUND OF THE INVENTION:

Audience involvement in television has practically re-invented modern television. Enough so, that the term neo-television has arisen. The term means TV shows where audience participation has become a major part of the show. The viewer becomes part producer, part-actor and of course, full time audience. This gives a viewer a sense of participation greater than the normal viewing experience.

Once the Internet become more accepted, it was clear that there was a synergistic effect between TV and the internet. The internet, even more than TV, lends itself to viewer participation. Performances can be streamed live or even recorded to a massive number of sites.

As is well known, TV audience participation shows have created their own genre. This particular genre has grown by leaps and bounds over the last decade. And, the genre has grown in world-wide participation. Internet based TV shows have grown almost exponentially with worldwide participation. At first audiences were asked to help find missing persons. These types of shows were particularly popular in Europe. Soon this genre spread to the US and attracted a significant audience.

Later, talent based TV shows debuted and invited audience participation. Such viewer participation increased the viewer base and already popular shows became significantly more popular. In certain talent based TV shows, the viewer could use their cell phones and vote for a certain performer via text. Later social media sites became a popular method of voting for performances.

Streaming through the internet enables viewers to view live or recorded performances. Recorded performances can be viewed using time shifting techniques to increase the viewer base or can be done on an on-demand basis. Additionally, the Internet enables simultaneous performances to be streamed without the viewer missing any parts of a particular performance.

What is proposed by applicant is a system and digital structure for giving artists both personal and monetary feedback through the use of both proprietary and non-proprietary software using digital devices. The system in accordance with the invention herein deviates from previous systems because the viewer can be polled over a safe and secure network.

### SUMMARY OF THE INVENTION

It is an object of the present invention to provide a digital system that enables a viewer to participate by giving a performing artist monetary and non-monetary feedback in a digital polling environment.

It is an additional object of this invention to provide a method of viewer feedback over both proprietary and non-proprietary websites using safe and secure proprietary and non-proprietary software.

To achieve the objects of the invention described above and those that will be understood hereafter, Applicant discloses a digital polling system and method for digitally polling viewers of performing artists. The system for digitally polling comprises:

a digital device for connecting to a cloud for viewing and listening to a one or more performing artists;

the digital device including a micro-processor, the micro-processor including software, which allows a viewer to see and listen to one or more performing artists;

the software having a user interface; and

the interface means including means for requesting tipping information and including means for receiving viewer instructions regarding tipping.

In an exemplary embodiment of the system of the present invention, private and secure software is used for viewing performances, defining performance content and responding to tipping request and processing financial information.

In another exemplary embodiment of the system of the present invention, the instant invention defines a method of digital polling, wherein the steps comprise:

viewing and listening to a performing artist at the designated website using digital means, such website defining a starting point, what is viewed and listened to defining performance content;

viewing such performance content on the designated website;

receiving a first prompt from the proprietary software, after a predetermined time, requesting voluntarily tip information for the performing artist being viewed;

using digital to communicate a response to the first prompt;

if responding affirmatively, receiving a second prompt requesting information on amount of tip;

using the digital device to communicate to the proprietary software, and communicating the amount of the tip in response to the second prompt;

if responding negatively to tipping, or after completing tip information, after responding affirmatively, receiving the next prompt requesting viewer information to continue viewing the same artist or to return to starting point.

In another exemplary embodiment of the system of the present invention, the instant invention defines a method of digital polling using a proprietary website, which uses proprietary software, which is private and secure software. The method of this exemplary embodiment comprises the steps of:

viewing a performing artist at the proprietary website using a digital device, such website defining a starting point;

interfacing with the proprietary software at the designated website to register as a user;

creating a user profile using the proprietary software;

viewing such performing artists on the designated website;

receiving a first prompt from the proprietary software, after a predetermined time, requesting voluntarily tip information for the performing artist being viewed;

using digital to communicate a response to the first prompt;

if responding affirmatively, receiving a second prompt requesting information on amount of tip;

using digital means to communicate to the proprietary software, and communicating the amount of the tip in response to the second prompt;

if responding negatively to tipping, or after completing tip information, after responding affirmatively, receiving the next prompt requesting viewer information to continue viewing the same artist or to return to starting point.

In another exemplary embodiment of the system of the present invention, which utilizes the private and secure network, when the viewer enters the user profile information, such information includes financial information. After entering such financial information, the viewer, at his options, decides to use a single prompt to respond affirmatively to the first prompt and also enters the amount of the tip. Such stream lining of the above method defines one-click tipping.

It is an advantage of the present invention to provide a system and method for giving performance artists feedback, both monetary and non-monetary using a digital structure akin to neo-television.

It is another advantage of the present invention to provide a method and system that uses a safe and secure proprietary digital network to protect viewer financial information while at the same time providing the viewer with a convenient one click option for giving financial feedback to the performing artist.

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is a schematic representation of viewers using a digital system to view performing artists.

FIG. 2 is a flow chart illustrating an exemplary embodiment of the method of the invention for giving feedback to a performing artist.

FIG. 3 is a flow chart illustrating an exemplary embodiment of the method of the invention for giving feedback to a performing artist over a proprietary network.

### DETAILED DESCRIPTION OF THE INVENTION

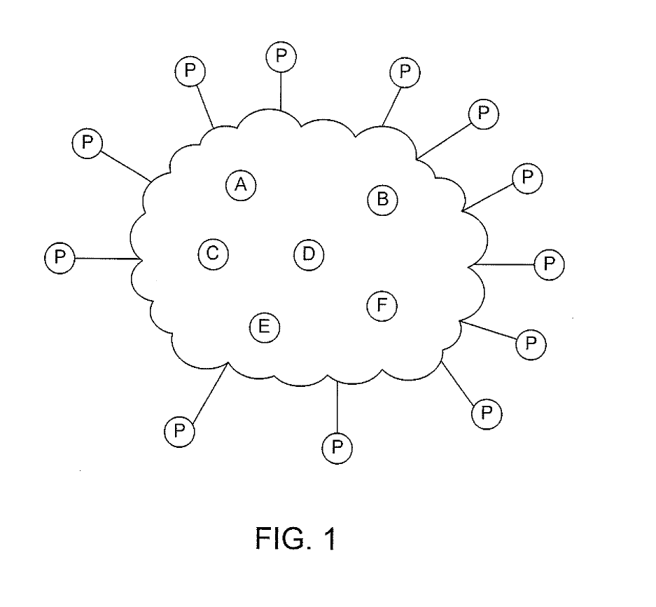

The invention will now be described in detail with respect to FIGS. 1-3.

As shown, FIG. 1 is a schematic representation of the method and apparatus of the invention disclosed in use. Viewers or participants, P, create their own digital connection to a cloud or the internet as shown. The viewers listen to any one of a number of artists, A, B, C . . . and so on, as depicted in FIG. 1.

Typically, a viewer has a digital device capable of connecting his or herself to the cloud or internet. The digital device can be a smart phone, a note pad, a laptop or a desk top computer. Or really, any device that allows a viewer to interface with the cloud or Internet. The viewer must be able to hear the artist clearly as well view the performance content. Additionally, the device must be capable of interfacing with the interface of the digital connection for providing viewer information and feedback information to the viewer. Once the connection is fully established, the viewer can then become a participant.

Upon responding to a prompt from the digital network, the viewer can enter his or her feedback to the performance content. Additionally, using the method of the invention, the viewer feedback is optionally, in the form of a financial renumeration, for example, a tip or $1, $5, $10 or so on. Exemplary embodiments of the invention provide for the viewer to participate by writing in their own financial renumeration and also providing written or verbal feedback specific to the individual artist based upon the performance content viewed.

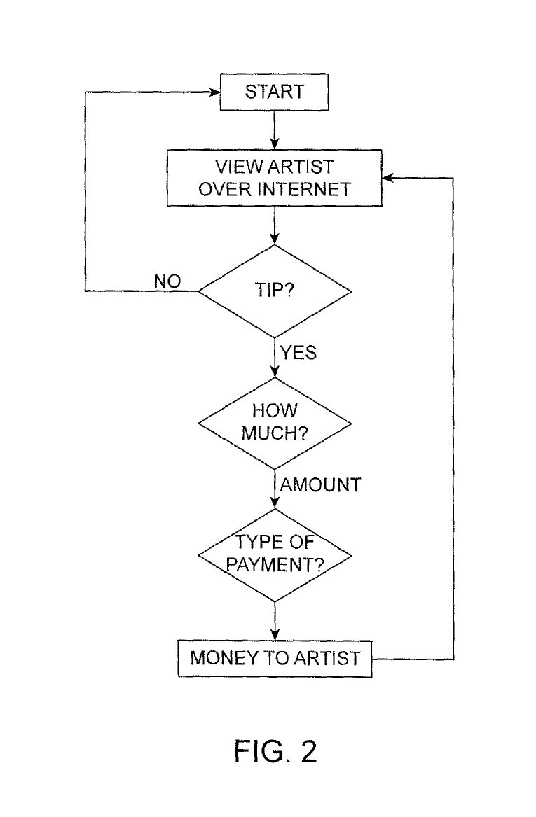

With particular reference to FIG. 2, there is shown a flow chart illustrating an exemplary embodiment of the invention. In this embodiment, a publically available website using non-proprietary software is used to connect the viewer with the performance content.

In the exemplary embodiment depicted in FIG. 2, the viewer uses a digital device to connect to the cloud or internet as depicted in the illustration of FIG. 1. Again, using the viewer's digital device, the viewer connects to a hosted website for viewing performing artists. Using site specific software, the viewer registers either under his or her own name a pseudonym. Applicant has found that Sparkreel Video software is satisfactory for this purpose. Additionally, Sparkreel Video software is readily available and reliable and has been found fit for the intended purpose herein.

Upon registration, the Sparkreel Video software allows viewers to immediately vote or be polled or at the very least start the tipping and feedback process. As the viewer watches the artist, he or she may initiate feedback with comments. The software is provided with screen options to permit viewer participation. After a predetermined period of time, which can be set to suit the website operator based upon its viewing audience participation, the viewer receives a message requesting whether the viewer would like to participate in rewarding the artist which is currently being viewed. Additionally, other options for giving the performing artist feedback are provided. The viewer can make an immediate “yea” or “nay” or defer the decision to a later time.

The predetermined period of time is adjustable. For example, it can be set initially as 3 minutes and moved 1 minute in either direction until such time as the optimum time was reached. In other exemplary embodiments, 30 second intervals are available. In other embodiments the predetermined time is simply set to whatever period is desired.

If the viewer decides to become a participant, he or she will receive a second prompt requesting the amount of the tip or other feedback information. At that time, the viewer can give his or her financial information over the safe and secure system provided by Sparkreel Video.

The viewer specifies the amount and authorizes the charges on his or her credit card or PayPal or other financial source using his or her own digital device which is connected to the cloud or Internet. The Sparkreel Video software handles the transaction in a safe and secure manner.

The viewer can also participate in giving feedback to the artist in a written or verbal form. Of course, the viewer's digital device must be capable of transmitting such verbal feedback. Other forms of feedback such as visual message are also within the spirit and scope of the invention. Also, within the spirit and scope of the invention, the software may cause a prompt to be sent to ask the viewer the type of feedback being given or the viewer may on his or her own initiative send the feedback and designate the type of feedback being sent.

At the option of the website operator, the feedback may be edited for content. For example, Disqus, edits comments for profanity and moderates them so as not to be overly offensive. The very same or stricter or more lenient rules apply to the website herein at the option of the website operator. Such editing is well within the spirit and scope of the invention.

After the viewer determines the type of payment as well as the amount, the money and other feedback is sent to the proper channels including to an account set up for the performing artist. The software handles the transaction seamlessly and in a safe and secure manner.

In an exemplary embodiment, once the tip is paid or a negative response is made by the viewer, the viewer can, by his or her own selection, be returned to the viewing artistic content or alternatively to the start. At the time of registration, in an exemplary embodiment, the viewer can make a pre-election as to the place of return after feedback. Of course, it will be appreciated that no tip is a form of feedback for the purposes of the methodology of the instant invention.

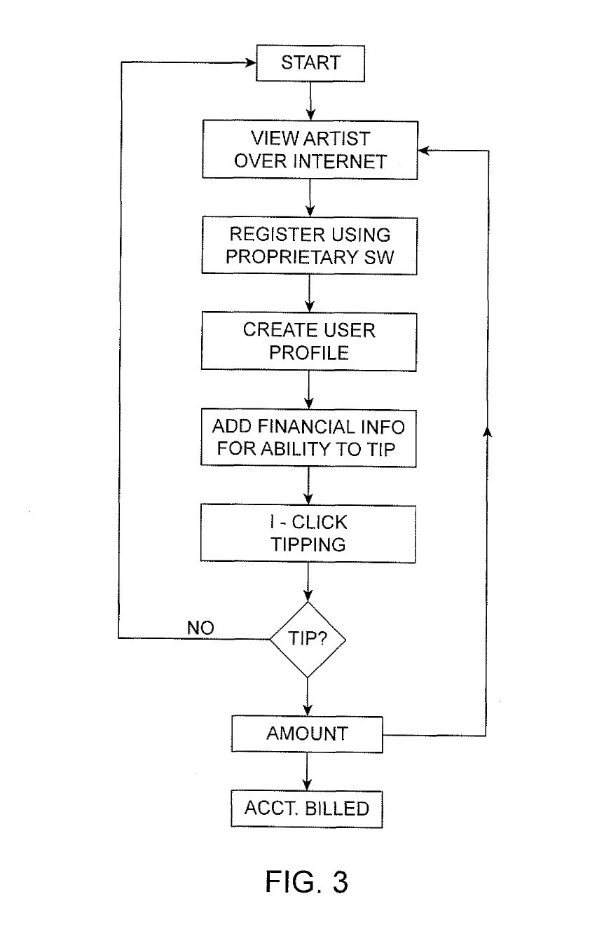

With particularly reference to FIG. 3, there is illustrated another exemplary embodiment of the method of digital polling. In the particular embodiment illustrated in FIG. 3, the method includes the use of proprietary software through the destination website.

Similar to the method depicted in FIG. 2, the viewer starts by using his or her digital device to connect to the website destination through the cloud or the Internet. Using site specific software, the viewer registers either under his or her own name a pseudonym. In the embodiment of FIG. 3, the website uses proprieatary software. For example, the Sparkreel Video software is modified for the intended purpose. Namely, the viewer enters the website and registers as a user. The viewer then creates, at his or hers discretion, a user profile. The viewer's profile is stored in a safe and secure method by using the proprietary software at the designated website. The profile is remembered each and every time the viewer accesses the designated website. In an exemplary embodiment of the method in accordance with this invention, the viewer includes the necessary information to complete any and all financial transactions without further reference to the user profile or further input from the user.

Known software can be modified for the purpose intended above and made proprietary within the spirit and scope of this invention. For example, and as stated above, the Sparkreel Video software is readily modified to facilitate the operations described herein available and reliable and has been found fit for the intended purpose herein as described above.

As noted above, upon registration, the Sparkreel Video software allows viewers to immediately vote or be polled. With the proprietary software in accordance with the invention, the tipping process is also immediate at the viewer's option. Since all the financial information has already been entered, no further dialog is needed between the website and the viewer except the amount, of a tip is desired.

Similar to the method described with respect to FIG. 2, as the viewer watches the artist, he or she may initiate feedback with comments or tipping. The proprietary software is provided with screen options to permit viewer participation. After a predetermined period of time, which can be set to suit the website operator based upon its viewing audience participation, the viewer receives a message requesting whether the viewer would like to participate in rewarding the artist which is currently being viewed. Additionally, other options for giving the performing artist feedback are provided. The viewer can make an immediate “yea” or “nay” or defer the decision to a later time.

The predetermined period of time is adjustable. For example, it can be set initially as 3 minutes and moved 1 minute in either direction until such time as the optimum time was reached. In other exemplary embodiments, 30 second intervals are available. In other embodiments the predetermined time is simply set to whatever period is desired.

If the viewer decides to become a participant, he or she will receive a second prompt requesting the amount of the tip or other feedback information. At that time, the viewer can give his or her financial information over the safe and secure system provided by the proprietary software.

The viewer specifies the amount and authorizes the charges on his or her credit card or PayPal or any other financial source using his or her own digital device which is connected to the cloud or internet. The Sparkreel Video software handles the transaction in a safe and secure manner using the modified proprietary software.

The viewer can also participate in giving feedback to the artist in a written or verbal form. Of course, the viewer's digital device must be capable of transmitting such verbal feedback. Other forms of feedback such as visual message are also within the spirit and scope of the invention. Also, within the spirit and scope of the invention, the software may cause a prompt to be sent to ask the viewer the type of feedback being given or the viewer may on his or her own initiative send the feedback and designate the type of feedback being sent.

At the option of the website operator, the feedback may be edited for content. For example, Disqus, edits comments for profanity and moderates them so as not to be overly offensive. The very same or stricter or more lenient rules apply to the website herein at the option of the website operator. Such editing is well within the spirit and scope of the invention.

After the viewer determines the type of payment as well as the amount, the money and other feedback is sent to the proper channels including to an account set up for the performing artist. The software handles the transaction seamlessly and in a safe and secure manner.

In an exemplary embodiment, once the tip is paid or a negative response is made by the viewer, the viewer can, by his or her own selection, be returned to the viewing artistic content or alternatively to the start. At the time of registration, in an exemplary embodiment, the viewer can make a pre-election as to the place of return after feedback. Of course, it will be appreciated that no tip is a form of feedback for the purposes of the methodology of the instant invention.

While the foregoing detailed description has described several embodiments of the method digital polling in accordance with this invention, it is to be understood that the above description is illustrative only and not limiting of the disclosed invention. Particularly, the polling method may be done live or via streaming or uses a hosted or unhosted network and may or may not use a graphic user interface. It will be appreciated that the embodiments discussed above and the virtually infinite embodiments that are not mentioned could easily be within the scope and spirit of this invention. Thus, the invention is to be limited only by the claims as set forth below.

What is claimed is:

1. A digital polling system and apparatus for digitally polling viewers of performing artists, comprising:
digital means for viewing and listening to a performing artist, defining performance content;
the digital means including a micro-processor, the micro-processor including software, which allows a viewer to see and listen to performance content;
the software having a user interface; and
the interface means including means for requesting tipping information and including means for receiving viewer instructions regarding tipping.

2. The digital polling system and apparatus of claim 1, wherein the digital means includes a computer connecter to a cloud network.

3. The digital polling system and apparatus of claim 1, wherein the system allows streaming of performance content.

4. The digital polling system and apparatus of claim 1, wherein the system allows streaming of performance content of one or more performing artists.

5. The digital polling system and apparatus of claim 1, wherein the digital means includes a computer connecter to the internet.

6. The digital polling system and apparatus of claim 1, wherein the digital means includes a computer connecter to a cloud network.

7. The digital polling system and apparatus of claim 1, wherein the user interface comprises a graphical user interface GUI.

8. A method of digital polling of performing artists at a designated website, comprising the steps of:
viewing a performing artist at the designated website using digital means, such website defining a starting point;
viewing such performing artists on the designated website;
receiving a first prompt from the proprietary software, after a predetermined time, requesting voluntarily tip information for the performing artist being viewed;
using digital to communicate a response to the first prompt;
if responding affirmatively, receiving a second prompt requesting information on amount of tip;
using digital means to communicate to the proprietary software, and communicating the amount of the tip in response to the second prompt;
if responding negatively to tipping, or after completing tip information, after responding affirmatively, receiving the next prompt requesting viewer information to continue viewing the same artist or to return to starting point.

9. A method of digital polling of performing artists at a designated website over the internet using proprietary software, comprising the steps of:
viewing a performing artist at the designated website using digital means, such website defining a starting point;
interfacing with the proprietary software at the designated website to register as a user;
creating a user profile using the proprietary software;
viewing such performing artists on the designated website;
receiving a first prompt from the proprietary software, after a predetermined time, requesting voluntarily tip information for the performing artist being viewed;
using digital to communicate a response to the first prompt;
if responding affirmatively, receiving a second prompt requesting information on amount of tip;
using digital means to communicate to the proprietary software, and communicating the amount of the tip in response to the second prompt;
if responding negatively to tipping, or after completing tip information, after responding affirmatively, receiving the next prompt requesting viewer information to continue viewing the same artist or to return to starting point.

10. The method of digital polling of claim 9, whereupon entering a user profile includes entering financial information and whereupon the viewer decides to use a single prompt to respond affirmatively to the first prompt and also enter the amount of the tip, defining one-click tipping.

11. The method of digital polling of claim 9, wherein the entertainment content is streamed live.

12. The method of digital polling of claim 9, wherein the entertainment content is streamed recorded.

13. The method of digital polling of claim 9, wherein the entertainment content is streamed live.

14. The method of digital polling of claim 9, wherein the entertainment content is on demand.

15. The method of digital polling of claim 9, wherein the viewer offers feedback as well as tipping.

16. The method of digital polling of claim 9, wherein the viewer optionally defers the decision to tip.

17. The method of digital polling of claim 9, wherein the website moderates the feedback comments at his own discretion.
